(19) United States
(12) Patent Application Publication
(10) Pub. No.: US 2011/0155505 A1
(43) Pub. Date: Jun. 30, 2011

(54) Connector device to prevent worker from falling

(76) Inventor: Feng Chia Liang, Taichung (TW)

(21) Appl. No.: 12/655,452

(22) Filed: Dec. 30, 2009

(51) Int. Cl. A62B 1/04

(52) U.S. Cl. 182/3

(57) ABSTRACT

A connector device for attaching to a rail of a scaffolding includes an attachment member attached to a lever for coupling to a worker, two gripping members slidably attached onto the lever for adjustably engaging with the rails of different width, and two brackets slidably attached to the gripping members and each having a jaw member for selectively engaging with the lever and for anchoring the gripping member to the lever at the selected position, two barrels are slidably attached onto the lever for mounting the gripping member and each include a slot for receiving the jaw member which is engageable with the ratchet teeth of the lever to anchor the gripping member to the lever at the selected position.

### BACKGROUND OF THE INVENTION

1. Field of the Invention

The present invention relates to a connector device, and more particularly to a connector device including an adjustable structure for adjustably attaching or mounting onto various rails of different width or structure of a scaffolding and for safely anchoring and retaining the worker on the scaffolding and for preventing the worker from falling from the scaffolding.

2. Description of the Prior Art

Typical connector devices or assemblies have been provided and developed for being engaged with or attached to the conventional scaffolding and coupled to the worker, and for safely anchoring and retaining or connecting the worker to the scaffolding and for preventing the worker from falling from the scaffolding while the worker is working on the scaffolding, normally, the typical connector devices or assemblies comprise one or more collars for slidably attaching or mounting onto the tubular posts or the tubular rails of the scaffolding for slidably connecting the worker to the scaffolding.

For example, U.S. Pat. No. 5,361,866 to Bell et al. discloses one of the typical connector devices or assemblies for use on scaffolding in order to prevent the worker from falling from the scaffolding.

However, the tubular posts and/or the tubular rails of the scaffolding may include different widths or shapes or structures or diameters, and the collars of the typical connector devices or assemblies may not be changed or adjusted to different widths or shapes or structures or diameters in order to suitably fit or attach or secure onto the tubular posts and/or the tubular rails of the conventional scaffolding that includes different widths or shapes or structures or diameters.

The present invention has arisen to mitigate and/or obviate the afore-described disadvantages of the conventional connector devices for use on scaffoldings.

### SUMMARY OF THE INVENTION

The primary objective of the present invention is to provide a connector device including an adjustable structure for adjustably attaching or mounting onto various rails of different width or structure of a scaffolding and for safely anchoring and retaining the worker on the scaffolding and for preventing the worker from falling from the scaffolding.

The other objective of the present invention is to provide a connector device including a cushioning or resilient structure for cushioning or resiliently engaging with the worker and for preventing the worker from being hurt while falling.

In accordance with one aspect of the invention, there is provided a connector device for attaching to a rail of a scaffolding comprising a lever including two side portions each having a plurality of ratchet teeth formed thereon, an attachment member attached to the lever for coupling to a worker, two gripping members slidably attached onto the lever for adjustably engaging with the rail and for adjustably attaching and mounting the gripping members and the lever to the rail, and two brackets slidably attached to the gripping members respectively and each including a jaw member for selectively engaging with the ratchet teeth of the lever and for anchoring and securing the gripping member to the lever at a selected position and for solidly or stably attaching or securing the connector device to the rail of the scaffolding.

Two barrels may further be provided and each include a bore formed therein for slidably receiving the lever and for slidably attaching the barrel onto the lever, and the gripping members each include an orifice formed therein for slidably receiving the barrel and for slidably mounting the gripping member onto the barrel and the lever.

The barrels each include a peripheral flange extended therefrom and having an outer diameter greater than that of the barrel for engaging with the gripping member and for limiting the gripping member to slide relative to or along the barrel and for anchoring and positioning or retaining the gripping member to the barrel.

The barrels each include a slot formed therein and communicative with the bore of the barrel, the jaw member of the bracket is selectively engaged through the slot of the barrel to selectively engage with the ratchet teeth of the lever and to stably anchor and secure the gripping member to the lever at the selected position.

The lever includes a guide channel formed in the side portions of the lever, and the barrels each include a key engaged into the bore of the barrel and slidably engaged with the guide channel of the lever for guiding the barrel to slide along the lever. The lever includes two end limiting members attached thereto for selectively engaging with the barrel and for limiting the barrel to slide relative to the lever.

The lever includes a seat provided on an intermediate portion thereof, and the attachment member is attached to the seat and includes a loop for coupling to the worker. The lever includes a peripheral recess formed in an outer peripheral portion of the seat for engaging with the attachment member and for stably anchoring the attachment member to the lever.

The brackets each include a groove formed therein, and a fastener is attached to the gripping member and slidably engaged with the groove of the bracket for slidably attaching the bracket to the gripping member.

The brackets each include at least one spring biasing member engaged with the gripping member for biasing and forcing the jaw member of the bracket to stably engage with the ratchet teeth of the lever.

The brackets each include a flap laterally extended therefrom, and at least one fastener threaded and engaged with the flap of the bracket for selectively engaging with the gripping member and for forcing the jaw member of the bracket to engage with the ratchet teeth of the lever.

The fastener includes an enlarged head formed thereon and extended out of the flap of the bracket for allowing the fastener to be rotated relative to the flap of the bracket and the gripping member. The fastener includes at least one lock nut threaded and engaged with the fastener for locking the fastener and the bracket to the gripping member.

The gripping members each include a finger member laterally extended therefrom for engaging with the rail and for gripping and attaching the gripping member and the lever to the rail. The gripping members each include a carrier attached to the finger member of the gripping member and having at least one rolling member for smoothly engaging with the rail.

The carrier includes a depression formed therein for engaging with the finger member of the gripping member and for anchoring the carrier to the finger member of the gripping member. The gripping members each include a casing attached and secured onto the finger member of the gripping member and engaged with the carrier for anchoring and positioning the carrier to the finger member or the gripping member.

The gripping members each include a spring biasing member engaged between the casing and the carrier for biasing the rolling member to engage with the rail and for slightly spacing or disengaging the finger member or the gripping member from the rail.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial side plan schematic view illustrating the operation of a connector device in accordance with the present invention for use on a scaffolding;

FIG. 2 is a perspective view of the connector device for use on the scaffolding;

FIG. 3 is a partial exploded view of the connector device for use on the scaffolding;

FIG. 4 is a plan schematic view of the connector device for use on the scaffolding;

FIGS. 5, 6, 7 are plan schematic views similar to FIG. 4; illustrating the operation of the connector device;

FIG. 8 is a partial side plan schematic view similar to FIG. 1; illustrating the operation of the connector device; and

FIGS. 9, 10 are enlarged partial side plan schematic views illustrating the operation of the connector device.

### DETAILED DESCRIPTION OF THE PREFERRED EMBODIMENT

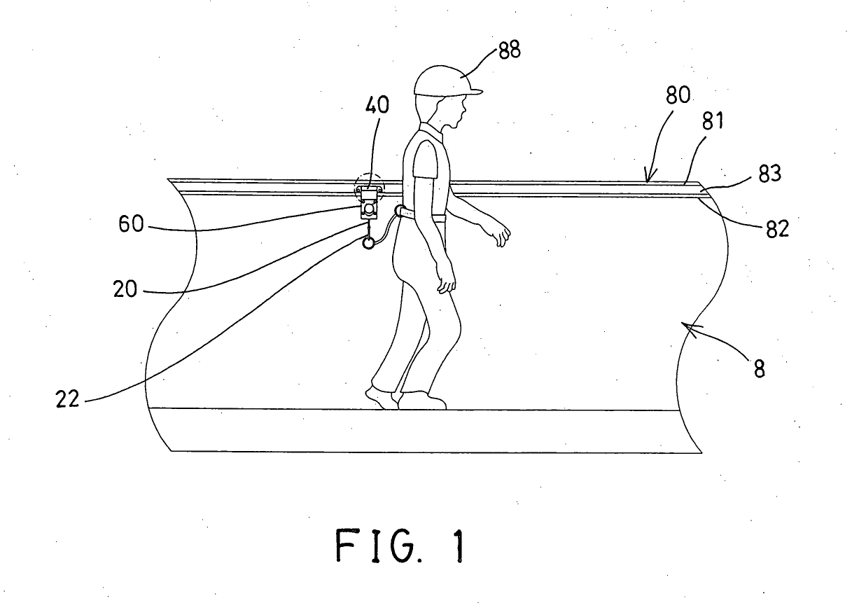

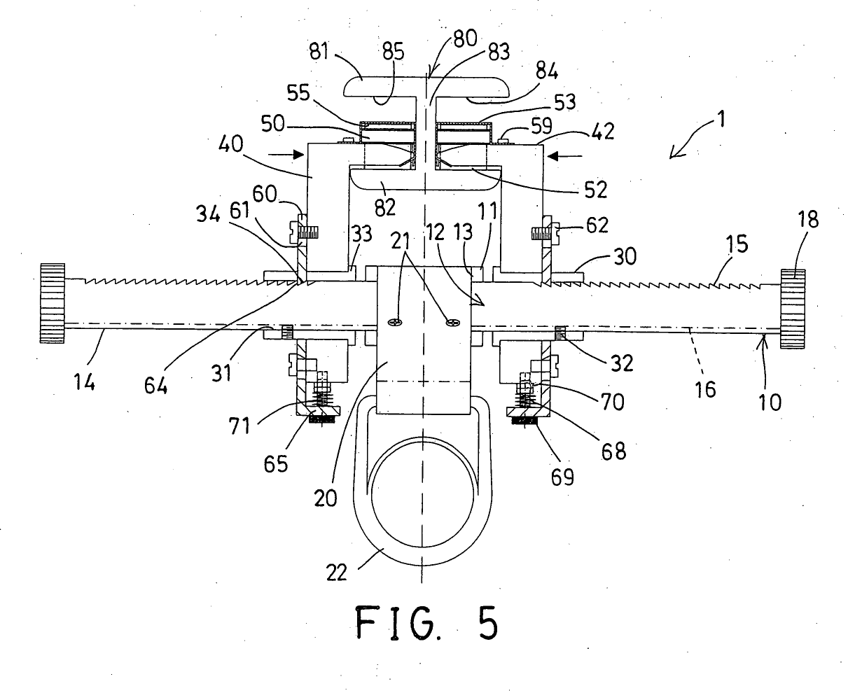

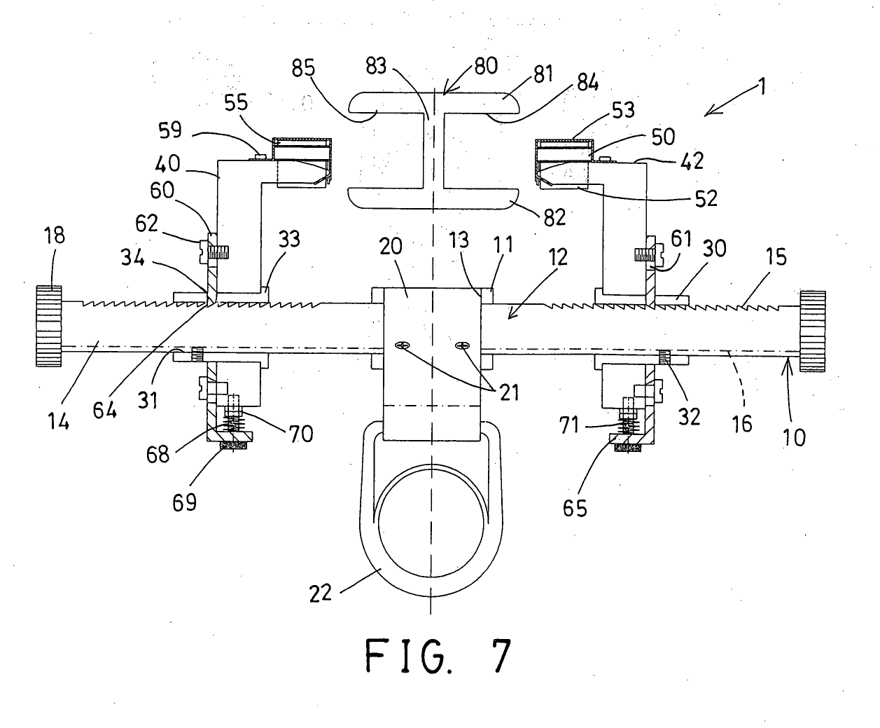

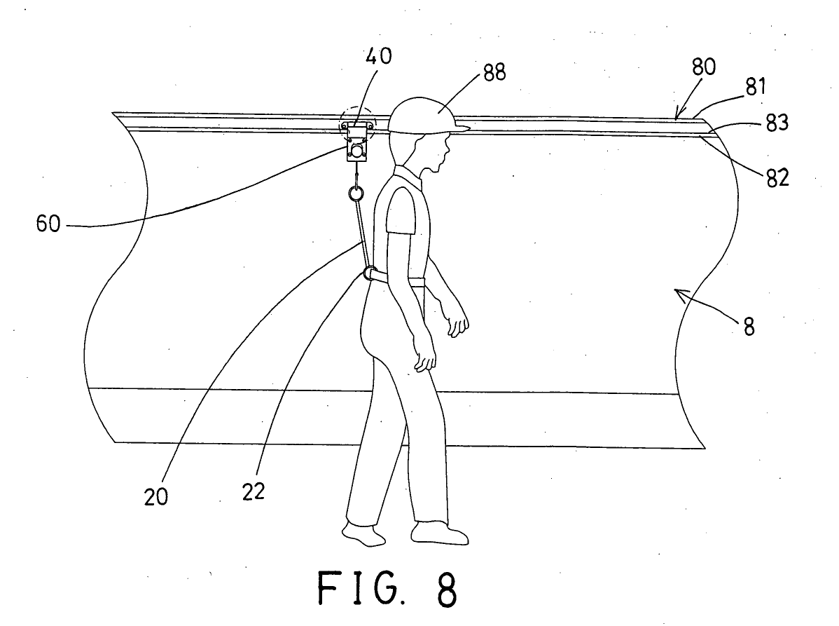

Referring to the drawings, and initially to FIGS. 1 and 8, a connector device 1 in accordance with the present invention is provided for being engaged with or attached to the conventional scaffolding 8, such as engaged with or attached to the tracks or rails 80 of the conventional scaffolding 8 and coupled to the worker 88 for safely anchoring and retaining or connecting the worker 88 to the scaffolding 8 and for preventing the worker 88 from falling from the scaffolding 8 while the worker 88 is working on the scaffolding 8, as shown in FIGS. 5-7, the tracks or rails 80 of the conventional scaffolding 8 may include an I-shaped structure having an upper bar 81, a lower bar 82 and an intermediate or vertical bar 83 coupled between the upper bar 81 and the lower bar 82 for forming or defining two side openings or spaces 84, 85 in the rail 80 or between the bars 81, 82.

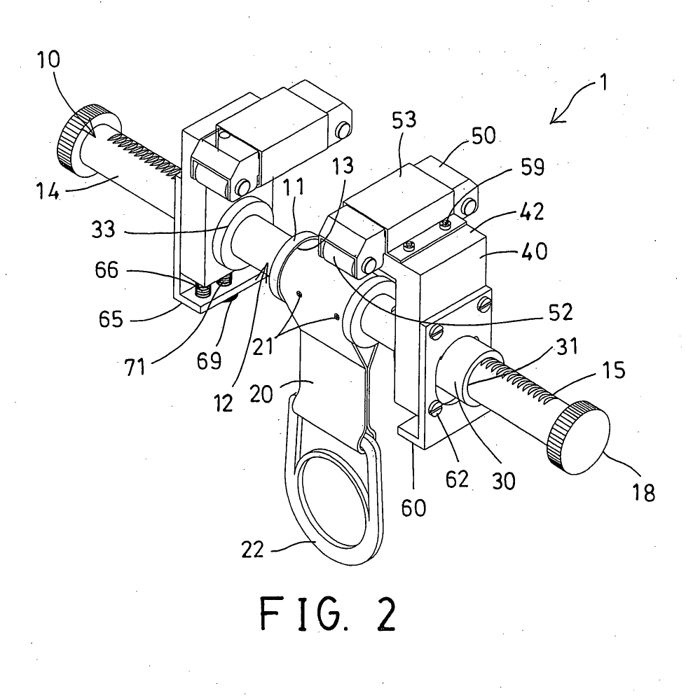

As shown in FIGS. 2-4, the connector device 1 comprises an elongate or longitudinal rod or lever 10 including a pulley or seat 11 formed or provided on the middle or intermediate portion 12 thereof for forming or defining two side portions 14, and having a peripheral recess 13 formed in the outer peripheral portion of the seat 11, and including a number of ratchet teeth 15 formed on the lever 10, such as formed on the upper portion of the two side portions 14 of the lever 10, and including a guide channel 16 formed therein, such as formed in the lower portion of the two side portions 14 of the lever 10, and including a screw hole 17 formed in the outer or free end portion of each of the two side portions 14 of the lever 10 for threading or attaching or engaging with an anchor or limiting member 18 which includes an outer diameter greater than that of the lever 10.

An attachment strap or member 20 is engaged with or attached or mounted onto the seat 11 and engaged with the peripheral recess 13 of the seat 11, and attached or secured to the seat 11 and/or the lever 10 with one or more fasteners 21 for solidly anchoring and positioning and securing the attachment strap or member 20 to the seat 11 and/or the lever 10 and for preventing the attachment member 20 from slipping sidewise relative to the seat 11 and/or the lever 10; and the attachment member 20 includes an attachment ring or loop 22 attached or mounted or secured or coupled onto the attachment member 20 and thus attached or mounted or secured onto the lever 10 for hooking or coupling to the worker 88 (FIGS. 1 and 8), for safely anchoring and retaining or connecting the worker 88 to the rail 80 of the scaffolding 8 and for preventing the worker 88 from falling from the scaffolding 8 while the worker 88 is working on the scaffolding 8.

The connector device 1 further includes two barrels 30 each having a bore 31 formed therein for slidably receiving or engaging with the lever 10 and for slidably attaching or mounting the barrels 30 onto the lever 10, one or more guides or keys 32 are attached or secured to the barrel 30 and engaged or extended into the bore 31 of the barrel 30 and slidably engaged with the guide channel 16 of the lever 10 for guiding the barrels 30 to suitably slide or move along the lever 10 and for preventing the barrels 30 from rotating relative to the lever 10. The barrels 30 each include a peripheral flange 33 extended radially and outwardly therefrom and having an outer diameter greater than that of the barrels 30.

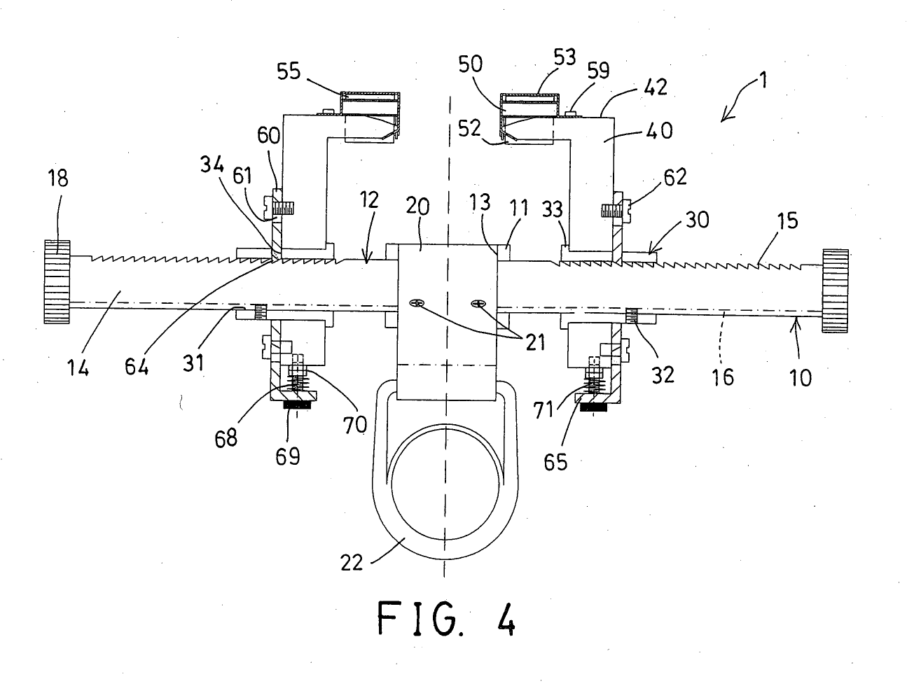

The barrels 30 each further include a slot 34 formed therein and intersecting or communicative with the bore 31 of the barrel 30 for allowing a portion of the ratchet teeth 15 of the lever 10 to be exposed or seen or reached through the slot 34 of the barrel 30, as best shown in FIGS. 4-7. The barrels 30 are contactable or engageable with the seat 11 and the limiting member 18 which may limit the barrel 30 to slide or move along or relative to the lever 10 and may prevent the barrels 30 from being disengaged form the lever 10. It is preferable, but not necessarily that the peripheral flange 33 of the barrel 30 is located closer to the seat 11 and located distal to the limiting member 18.

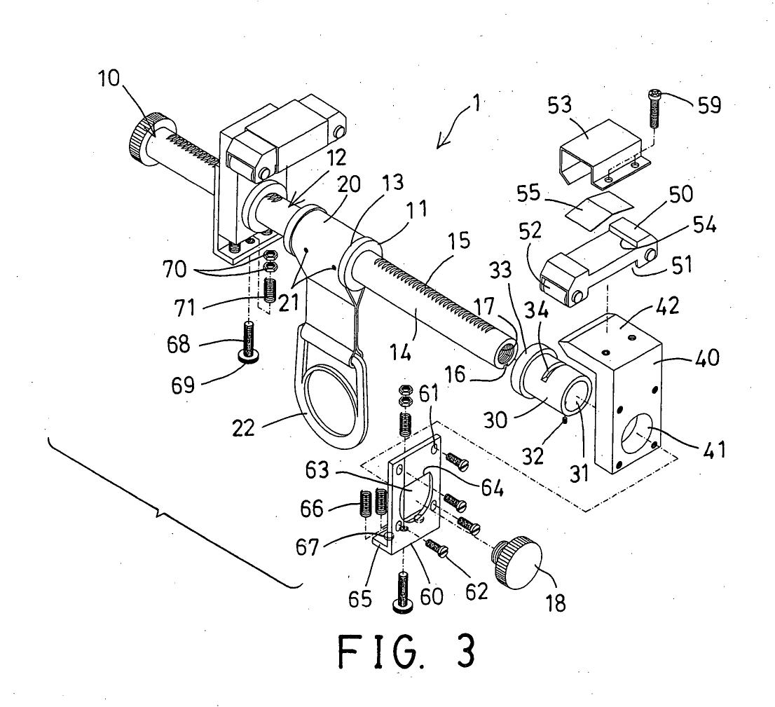

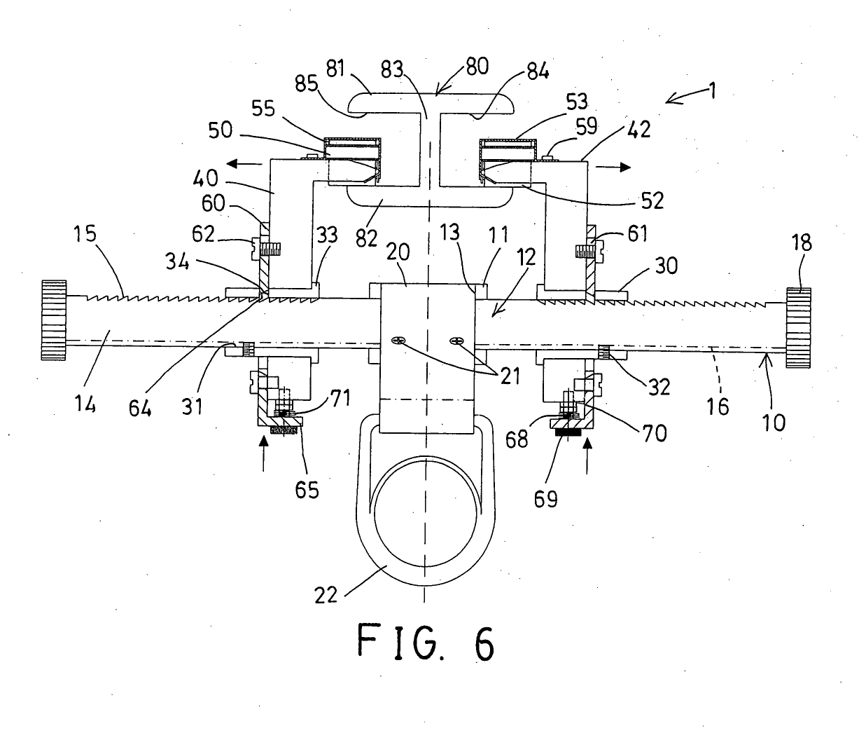

Two pawls or gripping members 40 each include an orifice 41 formed therein (FIGS. 3-5) for slidably receiving or engaging with the barrel 30 and for slidably attaching or mounting the gripping member 40 onto the barrel 30 and the lever 10, and each include a finger member 42 laterally extended therefrom for engaging with or into the spaces 84, 85 of the rail 80 (FIGS. 5-6) and for gripping or hooking or attaching or mounting or securing the gripping members 40 and the lever 10 to the rail 80 and thus for coupling or connecting the worker 88 to the rail 80 of the scaffolding 8. It is preferable, but not necessarily that the finger member 42 is tilted or perpendicular to the gripping member 40, and the gripping member 40 may be directly and slidably attached or mounted onto the lever 10 without the barrel 30. The gripping member 40 may be contacted or engaged with the peripheral flange 33 of the barrels 30 which may anchor and position or secure the gripping member 40 to the barrels 30.

A roller carrier 50 includes a depression 51 formed in the lower portion thereof for receiving or engaging with the finger member 42 or the gripping member 40 and for anchoring and attaching to the gripping member 40, and includes one or more (such as two) wheels or rollers or rolling members 52 pivotally or rotatably attached or coupled to the finger member 42 or the gripping member 40 and located beside the finger member 42 or offset from the finger member 42 for engaging with the lower bar 82 of the rail 80 and for smoothly coupling or attaching the finger member 42 or the gripping member 40 to the lower bar 82 of the rail 80 and for allowing the gripping members 40 and the lever 10 to be smoothly slid or moved along or relative to the rail 80.

An anchoring casing 53 is attached or mounted or secured onto the finger member 42 or the gripping member 40 with one or more fasteners 59 and contacted or engaged with the carrier 50 for stably anchoring or positioning or retaining the carrier 50 to the finger member 42 or the gripping member 40 and for preventing the carrier 50 from being disengaged form the finger member 42 or the gripping member 40. It is preferable that the carrier 50 includes a recess 54 formed in the upper portion thereof for receiving or engaging with a spring biasing member 55 which is engaged with or between the casing 53 and the carrier 50 for biasing or forcing the rolling members 52 to suitably and resiliently engage with the lower bar 82 of the rail 80.

Two frames or brackets 60 each include one or more oblong holes or grooves 61 formed therein are slidably attached or mounted or secured to the gripping members 40 with one or more fasteners 62 respectively and moved in concert with the gripping members 40 respectively, and the fasteners 62 are attached to the gripping members 40 and slidably engaged with the grooves 61 of the brackets 60 for slidably attaching or mounting the brackets 60 to the gripping members 40 respectively, and the brackets 60 each include an aperture 63 formed therein for receiving or engaging with the barrel 30 and for allowing the brackets 60 to be mounted or secured to the gripping members 40 respectively, and each include a jaw member 64 formed or extended into the aperture 63 thereof for selectively engaging through the slot 34 of the barrel 30 and to engage with the ratchet teeth 15 of the lever 10 and for anchoring or positioning and securing the gripping member 40 to the lever 10 at the required or selected position or location.

It is preferable that the brackets 60 each include a flap 65 laterally extended therefrom and tilted or perpendicular to the bracket 60, and one or more further spring biasing members 66 (FIGS. 2, 3) may further be provided and attached or secured to the bracket 60 and/or the gripping member 40 with one or more fasteners 67 (FIG. 3), and/or resiliently engaged with or between the flap 65 of the bracket 60 and the gripping member 40 for further biasing or forcing the jaw member 64 of the bracket 60 to suitably engage with the ratchet teeth 15 of the lever 10 and thus for suitably or stably or solidly anchoring or positioning and securing the gripping member 40 to the lever 10 at the required or selected position or location.

One or more further fasteners 68 may further be provided and threaded or engaged with the flap 65 of the bracket 60 for selectively engaging with the gripping member 40 and for solidly forcing the jaw member 64 of the bracket 60 to engage with the ratchet teeth 15 of the lever 10, and for solidly securing the gripping member 40 and the bracket 60 to the lever 10 at the required or selected position or location and for preventing the gripping member 40 and the bracket 60 from being moved along or relative to the lever 10. One or more lock nuts 70 may further be provided and threaded or engaged with the fasteners 68 for solidly securing the fasteners 68 to the gripping member 40 and the bracket 60, and one or more further spring biasing members 71 may further be provided and engaged with the fasteners 68 and engaged with the lock nuts 70 for solidly securing the fasteners 68 and the lock nuts 70 to the gripping member 40 and the bracket 60 and for preventing the fasteners 68 from becoming loose or disengaged from the gripping member 40 and the bracket 60.

The fasteners 68 each include an enlarged head 69 formed or provided on one end thereof and extended out of the flap 65 of the bracket 60 for allowing the fasteners 68 to be rotated relative to the flap 65 of the bracket 60 and the gripping member 40 by the users and/or with the driving tools (not shown), and thus for selectively or adjustably attaching or mounting the gripping members 40 and the brackets 60 to the lever 10 at the required or selected positions or locations after the finger members 42 of the gripping members 40 have been suitably engaged with the spaces 84, 85 and the lower bar 82 of the rail 80.

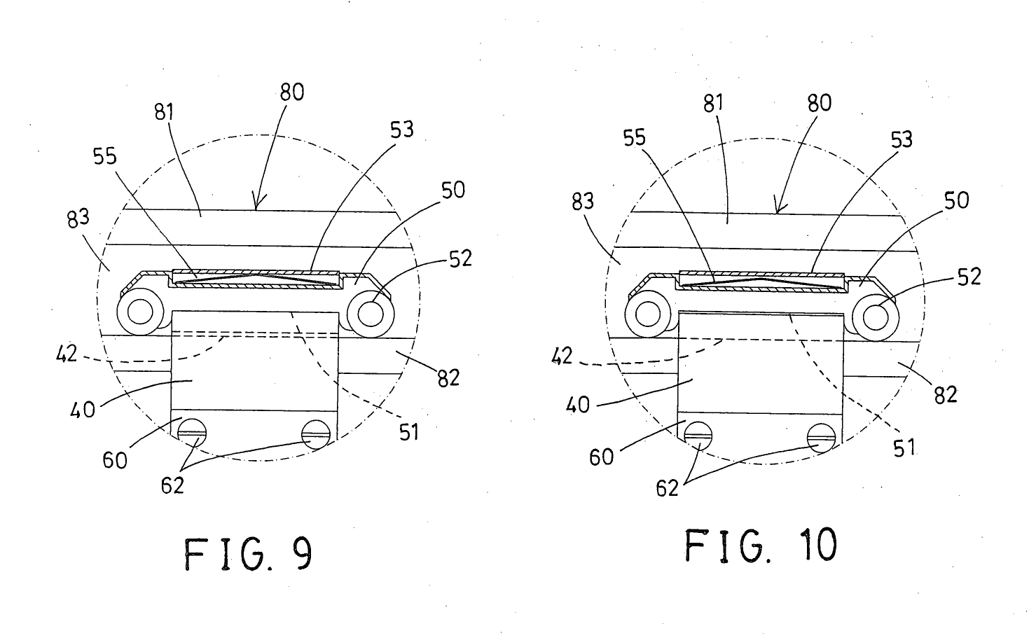

In operation, as shown in FIGS. 1 and 9, when the worker is safely supported on the scaffolding 8 and when the loop 22 of the attachment member 20 has not been pulled away from the lever 10 and the rail 80, the spring biasing member 55 may force the rolling members 52 to suitably and resiliently engage with the lower bar 82 of the rail 80, at this moment, the finger member 42 of the gripping member 40 is slightly disengaged from the lower bar 82 of the rail 80. As shown in FIGS. 8 and 10, when the worker is falling, the gripping members 40 and the lever 10 may be moved downwardly relative to the rail 80 to force the finger member 42 of the gripping member 40 to engage with the lower bar 82 of the rail 80, and the spring biasing member 55 may cushion the worker and may prevent the worker from being hurt while falling.

As shown in FIGS. 5, 6 and 7, when it is required to attach or mount or couple the connector device 1 onto the rail 80 or required to detach or disengage the connector device 1 from the rail 80, the fasteners 68 are unthreaded and disengaged from the gripping members 40 to release the brackets 60 from the gripping members 40 and to allow the brackets 60 to be moved relative to the gripping members 40, and to allow the jaw members 64 of the brackets 60 to be selectively disengaged from the ratchet teeth 15 of the lever 10, and thus for allowing the barrels 30 and the gripping members 40 to be selectively slid or moved along or relative to the lever 10 to the required or selected position or location, and thus for allowing the finger members 42 of the gripping members 40 to adjustably attach or mount or engage with the rails 80 of different width or structure of the scaffolding 8.

Accordingly, the connector device in accordance with the present invention includes an adjustable structure for adjustably attaching or mounting onto various rails of different width or structure of the scaffolding and for safely anchoring and retaining the worker on the scaffolding and for preventing the worker from falling from the scaffolding, and includes a cushioning or resilient structure for cushioning or resiliently engaging with the worker and for preventing the worker from being hurt while falling.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connector device for attaching to a rail of a scaffolding comprising:
a lever including two side portions each having a plurality of ratchet teeth formed thereon,
an attachment member attached to said lever for coupling to a worker,
two gripping members slidably attached onto said lever for adjustably engaging with said rail and for adjustably attaching and mounting said gripping members and said lever to said rail, and
two brackets slidably attached to said gripping members respectively and each including a jaw member for selectively engaging with said ratchet teeth of said lever and for anchoring and securing said gripping member to said lever at a selected position.

2. The connector device as claimed in claim 1 further comprising two barrels each including a bore formed therein for slidably receiving said lever and for slidably attaching said barrel onto said lever, and said gripping members each including an orifice formed therein for slidably receiving said barrel and for slidably mounting said gripping member onto said barrel and said lever.

3. The connector device as claimed in claim 2, wherein said barrels each include a peripheral flange extended therefrom and having an outer diameter greater than that of said barrel for engaging with said gripping member and for anchoring and positioning said gripping member to said barrel.

4. The connector device as claimed in claim 2, wherein said barrels each include a slot formed therein and communicative with said bore of said barrel, said jaw member of said bracket is selectively engaged through said slot of said barrel to engage with said ratchet teeth of said lever and to anchor and secure said gripping member to said lever at the selected position.

5. The connector device as claimed in claim 2, wherein said lever includes a guide channel formed in said side portions of said lever, and said barrels each include a key engaged into said bore of said barrel and slidably engaged with said guide channel of said lever for guiding said barrel to slide along said lever.

6. The connector device as claimed in claim 2, wherein said lever includes two end limiting members attached thereto for selectively engaging with said barrel and for limiting said barrel to slide relative to said lever.

7. The connector device as claimed in claim 1, wherein said lever includes a seat provided on an intermediate portion thereof, and said attachment member is attached to said seat and includes a loop for coupling to the worker.

8. The connector device as claimed in claim 7, wherein said lever includes a peripheral recess formed in an outer peripheral portion of said seat for engaging with said attachment member.

9. The connector device as claimed in claim 1, wherein said brackets each include a groove formed therein, and a fastener is attached to said gripping member and slidably engaged with said groove of said bracket for slidably attaching said bracket to said gripping member.

10. The connector device as claimed in claim 1, wherein said brackets each include at least one spring biasing member engaged with said gripping member for biasing and forcing said jaw member of said bracket to engage with said ratchet teeth of said lever.

11. The connector device as claimed in claim 1, wherein said brackets each include a flap laterally extended therefrom, and at least one fastener threaded and engaged with said flap of said bracket for selectively engaging with said gripping member and for forcing said jaw member of said bracket to engage with said ratchet teeth of said lever.

12. The connector device as claimed in claim 11, wherein said at least one fastener includes an enlarged head formed thereon and extended out of said flap of said bracket for allowing said at least one fastener to be rotated relative to said flap of said bracket and said gripping member.

13. The connector device as claimed in claim 11, wherein said at least one fastener includes at least one lock nut threaded and engaged with said at least one fastener for locking said at least one fastener and said bracket to said gripping member.

14. The connector device as claimed in claim 1, wherein said gripping members each include a finger member laterally extended therefrom for engaging with said rail and for gripping and attaching said gripping member and said lever to said rail.

15. The connector device as claimed in claim 14, wherein said gripping members each include a carrier attached to said finger member of said gripping member and having at least one rolling member for engaging with said rail.

16. The connector device as claimed in claim 15, wherein said carrier includes a depression formed therein for engaging with said finger member of said gripping member and for anchoring said carrier to said finger member of said gripping member.

17. The connector device as claimed in claim 15, wherein said gripping members each include a casing attached and secured onto said finger member of said gripping member and engaged with said carrier for anchoring and positioning said carrier to said finger member or said gripping member.

18. The connector device as claimed in claim 17, wherein said gripping members each include a spring biasing member engaged between said casing and said carrier for biasing said at least one rolling member to engage with said rail.
